(19) United States
(12) Patent Application Publication
(10) Pub. No.: US 2012/0062562 A1
(43) Pub. Date: Mar. 15, 2012

(54) APPARATUS AND METHOD TO IMPLEMENT A UNIVERSAL 3D IMAGING SYSTEM WITH AUTOMATIC SEARCH FOR 3D COMMUNICATION PROTOCOL

(76) Inventors: Chen Tai Chen, Tao Yuan (TW); Wen Chin Chen, Shin Chu (TW); Jing Shing Ding, Shin Chu (TW); Feng Pang Tu, Bian Chiao (TW); Guan Shing Yu, Shin Chu (TW)

(21) Appl. No.: 13/232,370

(22) Filed: Sep. 14, 2011

(30) Foreign Application Priority Data
Sep. 14, 2010 (TW) 99130968
Sep. 29, 2010 (CN) 201010298556.5

(51) Int. Cl. G06T 15/00

(52) U.S. Cl. 345/419

(57) ABSTRACT

An apparatus and method are disclosed to implement a universal 3D (3-Dimensional) image system with automatic search for 3D communication protocol. The apparatus includes a memory to store a plurality of communication protocols. The apparatus further includes a controller operatively coupled to the memory to detect a transmitted communication protocol by comparing the transmitted communication protocol with the plurality of communication protocols stored in the memory of the glasses. In addition, the controller receives and processes the 3D image data based on the transmitted communication protocol.

### CROSS-REFERENCE TO RELATED APPLICATIONS

The present Application for Patent claims the benefit of Taiwan Patent Application No. 099217744, filed on Sep. 14, 2010, and China Patent Application No. 2010 1029 8556.5, filed on Sep. 29, 2010.

### FIELD

This disclosure relates generally to an apparatus and method to implement a universal 3D (3-Dimensional) image system with automatic search for 3D communication protocol.

### BACKGROUND

3D movies are very popular in recent years which makes 3D films and content in high demand and which causes the 3D products to transform from just for the movies to a 3D display industry (for example: 3D TV). Humans could see the depth of the objects and the stereo pictures through visual perception called “depth perception.” With depth perception, users could judge the corresponding positions of objects in 3D space. Users' eyes are typically not in the same positions. The distance between two eyes is normally about five to seven centimeters. Therefore, as users see the binocular parallax, their brains will merge the images and create the sense of stereo pictures (or binocular cues). Further, human eyes could judge the distance of the object by accommodating the focus of the object in different distance by motion parallax, by perspective or by light. Humans could also use only one eye to determine the distance of the object. Therefore, to transform a 2D image into a 3D image, the right and left eyes have to see different pictures (i.e., binocular parallax), and the brain would merge the different pictures to form the 3D picture.

Currently, shutter glasses or lenses are typically used. The basic principle of shutter glasses is that images for the right and left eyes are displayed alternately on the screen at about doubled frequency rate, and the glasses will automatically cover the user's right and left eyes separately. The right eye is covered when the picture for the left eye is displayed on the screen, monitor, or television, and the left eye is covered when the picture for the right eye is displayed such that the two eyes receive two separate pictures. Although, the two eyes cannot watch the images at the same time, through the effect of human eyes temporary persisting vision, the user would still have the sense that he is watching the pictures simultaneously, thereby generating the stereo image.

The available 3D screens, monitors or televisions typically encode the 3D images with particular communication protocols, and the encoded signals are conveyed to the 3D glasses receiver by an emitter. After decoding the encoded signals received by the 3D receiver, the 3D glasses could process the image signals and turn the shutter glasses or lenses on/off according to the image signals. However, various manufacturers of 3D monitor or television sold in the market now use their own 3D glasses to match their own built-in communication protocols and 3D image signal emitters. In this situation, to watch the 3D film or content, users would have to use the 3D shutter glasses made by the same manufacturer of the 3D monitor or television for decoding purposes. Otherwise, the encoded codes could not be decoded, and the glasses could not be used to watch the 3D images. In other words, users would need to buy a 3D monitor and 3D glasses from the same manufacturer for image decoding. When multiple users watch 3D film or content simultaneously while wearing different brands of glasses, they would not be able to do so because the communication protocol decoders would be different.

### SUMMARY

An apparatus and method are disclosed to implement a universal 3D (3-Dimensional) image system with automatic search. The apparatus includes a memory to store a plurality of communication protocols. The apparatus further includes a controller operatively coupled to the memory to detect a transmitted communication protocol by comparing the transmitted communication protocol with the plurality of communication protocols stored in the memory of the glasses. In addition, the controller receives and processes the 3D image data based on the transmitted communication protocol.

### BRIEF DESCRIPTION OF THE DRAWINGS

FIG. 1 shows a pair of universal 3D glasses according to one embodiment of the invention.

FIG. 2 shows a functional block diagram of the search module according to one embodiment of the invention.

FIG. 3 is a diagram illustrating a 3D glasses in a 3D image system according to one embodiment of the invention.

FIG. 4 is a flow chart diagram showing how the 3D system generally processes auto-search and frequency matching according to one embodiment of the invention.

### DETAILED DESCRIPTION

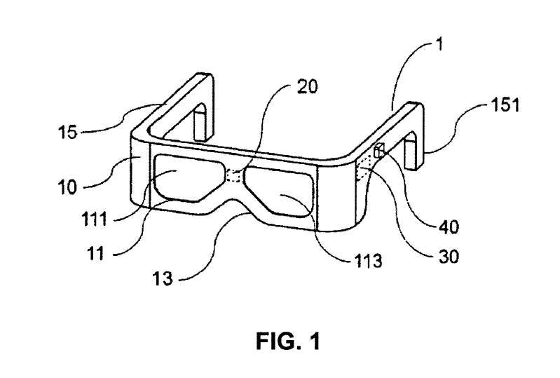

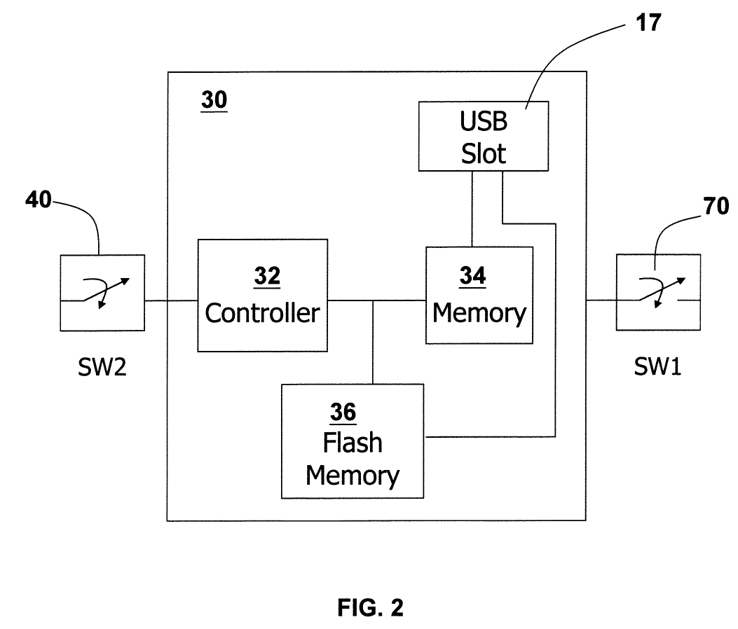

FIG. 1 shows an embodiment of the universal 3D glasses. As shown in FIG. 1, the universal 3D glasses include a frame 11 with a lens holder 10. The glasses frame 11 has a left lens, 113 and a right lens 111. The nose piece 13 is in the middle of the glasses frame, 11. A pair of arms or temples 15 is connected to the sides of the lens holder 10, and also forms an ear frame 151 at the end. In one embodiment, the signal receiver 20 is placed in the glasses frame between the lens holders 10, and is used to control the on/off of the right lens 111 and left lens 113. The universal 3D glasses include the search module 30 placed within the frame. The controller 32 (shown in FIG. 2) has input ports connected to the signal search key 40 to receive signals from the search key 40. The controller is also connected to the memory 34 and the flash memory 36.

In one embodiment, the universal 3D glasses include memory to store multiple communication protocols to enable the 3D glasses to communicate with multiple brands or types of 3D monitors or televisions. The universal 3D glasses also include a controller that is used to automatically search for the appropriate communication protocol between the 3D monitor or television and the 3D glasses. As such, the users could watch multiple brands or type of 3D monitors or televisions using the same pair of 3D glasses that is capable of quickly searching from the glasses internal memory for the appropriate communication protocol with the corresponding brand or type of 3D monitor or television, making watching 3D films or content more convenient.

In an alternative embodiment, as various brands of communication protocols are included in the 3D system memory, searching and comparing the specifications of communication protocol will be faster. The universal 3D glasses could be used to watch displays from many or all brands or types of 3D monitors or televisions.

In another embodiment, the universal 3D glasses include a communication port which could be a USB port or other types of ports. Through the communication port, various communication protocols for different brands of 3D monitors or televisions could be inputted or entered into the memory of the 3D glasses. As such, new communication protocols could be easily entered or added to the 3D glasses.

As seen, the invention is generally a 3D system with auto-searching of the appropriate communication protocol and its method. The 3D system includes a universal 3D glasses which include has a frame, arms (or temples), a signal receiver, one pair of shutter lenses connected to a signal receiver, a memory connected to the signal receiver and the shutter lenses, a flash memory connected to the signal receiver, shutter lenses and the memory, and a signal search key connected to the memory and the flash memory, and a communication port (such as a USB port) connected to memory. Therefore, the universal 3D glasses enable users to watch various brands of 3D monitors or televisions and to automatically search the appropriate communication protocol through the flash memory to make watching 3D films or content more convenient.

The method of the 3D system with auto-search the corresponding frequency includes: the 3D images which have the first set of communication protocol memory which could store at least one set of communication protocol, and a signal receiver to receive the 3D images and has the first set of communication protocol. When the communication protocol search key is pressed, the system begins to search for the communication protocol. Comparing the first communication protocol means that comparing the first communication protocol received by the receiver with the communication protocol stored advanced in the memory. The first set of communication protocol is stored into flash memory if more than one set of communication protocols are set as the initial set of communication protocols.

FIG. 2 shows a functional block diagram of the search module. As shown in FIG. 2, when a 3D film or content is played on a 3D monitor or television, the user would wear the universal 3D glasses 1 and would press the power switch 70. The controller 32 in the search module 30 would decode the communication protocol transmitted from the 3D monitor or television. When the universal 3D glasses 1 correctly decodes the 3D images signals sent by the 3D monitor or television, the signal receiver 20 can receive the 3D image signal sent by the 3D monitor or television. Therefore, the users can watch the 3D film or content displayed on the 3D monitor.

If the users wear the universal 3D glasses and press the power on/off switcher 70 and still could not watch 3D images broadcasted on the 3D monitor, it means that the controller 32 in the search module 30 could not correctly decode the communication protocol send by the 3D monitor. Therefore, the user could not watch the 3D files broadcasted on the 3D monitor. In this situation, the user could press the signal search key, 40, and the controller 32 in the search module 30 would compare the communication protocol sent by the 3D monitor with the communication protocols previously placed in the memory 34 to find the appropriate communication protocol.

After the controller 32 finds the corresponding communication protocol in the memory, 34, the received signal will be decoded based on the found communication protocol. When the controller 32 is able to correctly decode the communication protocol, the signal receiver 20 would receive the 3D images signals send by the 3D monitor, and the right lens, 111, and the lens 113 will be turned on or off based on the received 3D images signals to form 3D images.

In one embodiment, hundreds or more of 3D communication protocols could be inserted or placed into the memory 34 to accommodate different brands of 3D monitors or televisions available in the market. When the user presses down the signal search key 40, the controller 32 in the search module 30 would compare the 3D communication protocol transmitted and used by the 3D monitor or television with the 3D communication protocols placed in the memory 34.

In an embodiment, if each comparison takes 3 seconds, the user would wait for 300 seconds if the correct or known 3D communication protocol is found at the 100^{th} comparison. To reduce search time, the flash memory 36 is added and is connected to the controller 32 and the memory 34. When the controller, 32, finds the appropriate or known 3D communication protocol in the memory 34, the controller 32 would decode the communication protocol and store the communication protocol in the flash memory 36. In one embodiment, the controller stores the top ten (10) frequently-used communication protocols into the flash memory. In another embodiment, the controller would fill the flash memory up with as many used 3D communication protocols as the flash memory would hold. After the user presses the signal search key, the controller 32 in the search module 30 would initially search the flash memory 36 for the correct or known communication protocol to reduce the search time. If the controller 32 could not find the appropriate communication protocol in the flash memory 36, the controller 32 would then access the memory 34 to find the appropriate communication protocol.

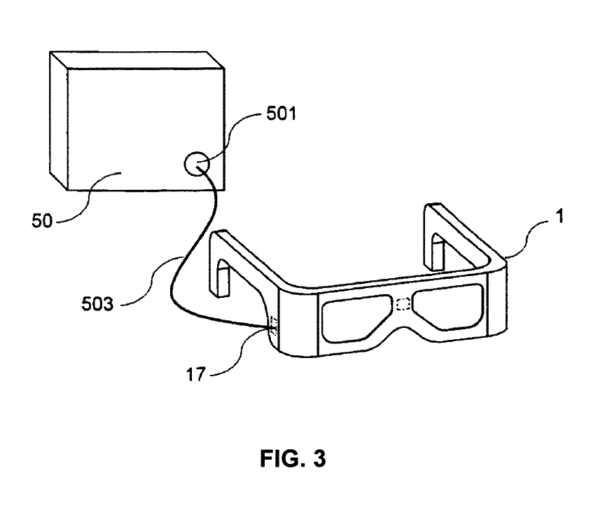

FIG. 3 is a diagram illustrating a 3D glasses in a 3D image system. As shown in FIG. 3, the universal 3D glasses include a USB port 17. The USB port 17 could be connected to the slot 501 of a computer 50 through the transmission line 503. In one embodiment, the new 3D communication protocols could be inputted or entered into memory 34 or to flash memory 36. In this embodiment, the USB port 17 allows the users to input new or additional communication protocols to memory as new additional communication protocols are made available. As such, the users could input or enter the new communication protocols into the memory 34 or flash memory 36 of the universal 3 D glasses through the transmission line 501. Furthermore, the users could delete the unwanted 3D communication protocols to save space in the memory 34 as well as flash memory 36.

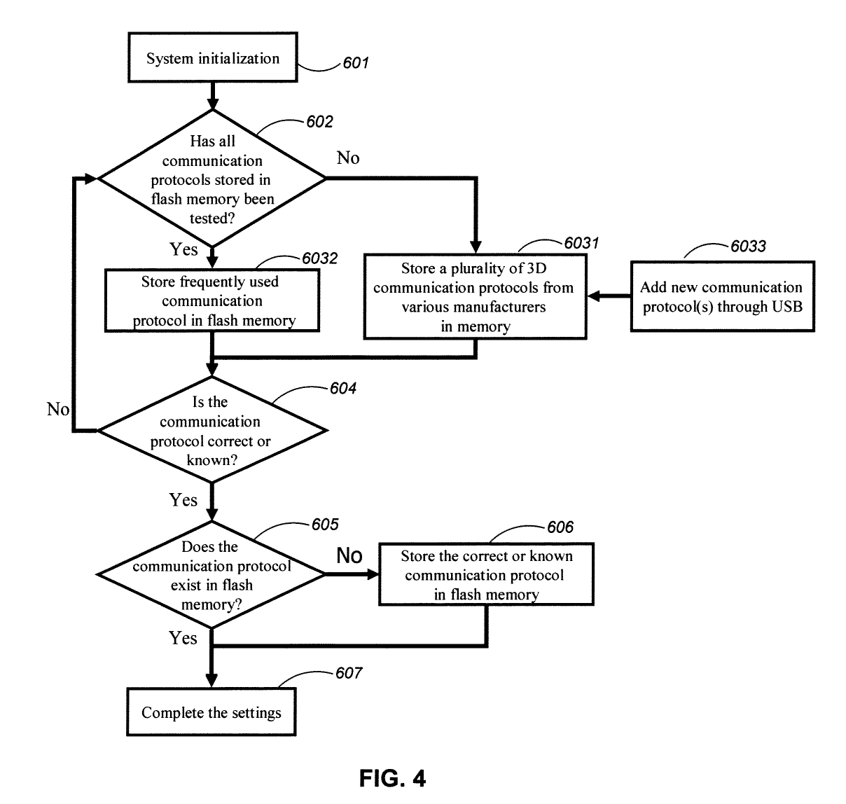

FIG. 4 is the flow chart diagram showing how the 3D system generally processes auto-search and frequency matching. As shown in FIG. 4, after the 3D images signals with the communication protocol are emitted by the emitter, please refer to step 601. In the beginning, the universal 3D glasses 1 has to perform the system initialization as shown in step 601. The signal search key 40 is pressed to ask the system to perform the auto-search. At the same time, the signal receiver 20 in the universal 3D glasses would receive the 3D images signals sent by the emitter. Referring to steps 602 and 603, the universal 3D glasses 1 would initially search the flash memory 36 for information or data pertaining to frequently-used communication protocols. In the initial stage, the flash memory 36 may not contain any information or data. After searching the flash memory 36 as shown in steps 602 and 6032, the universal 3D glasses 1 will search for corresponding communication protocols available in the memory 34 as shown in step 6031. If the universal 3D glasses 1 do not find the appropriate 3D communication protocol, it means that the communication protocol sent by the 3D monitor or television does not exist in the memory, despite the fact that many 3D communication protocols have already been stored in the memory. Therefore, as shown in step 6033, the users have to adopt the method as shown in FIG. 3, connect the computer 50, through the USB transmission line and download the new communication protocol into memory 34.

In step 604, the universal 3D glasses 1 would check to see whether the corresponding and correct or known communication protocol is available from the memory 34 and/or the flash memory 36. In sum, each communication protocol will be tested one by one. If the protocol is incorrect (and user is unable to watch the 3D images), the universal 3D glasses 1 will go back to step 602 and search again for other communication protocols stored in the memory 34 and/or flash memory 36 through steps 6031 and 6032. If the correct or known communication protocol is detected and (the user could watch the 3D images), step 605 would be entered where the universal 3D glasses 1 could determine whether the correct or known 3D communication protocol has been stored in the flash memory 36. If the correct or known communication protocol has not been stored in the flash memory 36, the protocol would be stored in flash memory in step 606. Step 607 is then entered to complete the settings.

From step 605, if the communication protocol has already been stored in the flash memory 36, step 607 would be entered to complete the settings.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method to implement a 3D image system, comprising:
transmitting a communication protocol used to transmit 3D image data;
storing a plurality of communication protocols in a memory; and
detecting the transmitted communication protocol by comparing the transmitted communication protocol to the plurality of communication protocols stored in the memory;
receiving and processing the 3D image data based on the transmitted communication protocol.

2. The method of claim 1, further comprises storing a plurality of frequently-used communication protocols in a flash memory.

3. The method of claim 2, further comprises searching the flash memory, prior to searching the memory, for a correct or known communication protocol.

4. The method of claim 2, further comprises searching the memory, after searching the flash memory, for a correct or known communication protocol.

5. The method of claim 4, further comprises storing the correct or known communication protocol in the flash memory.

6. The method of claim 1, further comprises adding new communication protocols.

7. The method of claim 1, further comprises deleting stored communication protocols.

8. A 3D image system, comprising:
a 3D monitor or television to transmit a communication protocol used to transmit 3D image data; and
a 3D glasses operatively coupled to the 3D monitor or television to detect the transmitted communication protocol, the 3D glasses includes a memory to store a plurality of communication protocols, and a search module to detect the transmitted communication protocol by comparing the transmitted communication protocol to the plurality of communication protocols stored in the memory;
wherein the 3D glasses receive and process the 3D image data based on the transmitted communication protocol.

9. The system of claim 8, wherein the 3D glasses includes a flash memory to store a predetermined number of frequently-used communication protocols.

10. The system of claim 9, wherein the search module includes a controller to search the flash memory, prior to searching the memory, for a correct or known communication protocol.

11. The system of claim 10, wherein the search module includes a controller to search the memory, after searching the flash memory, for a correct or known communication protocol.

12. The system of claim 11, wherein the controller stores the correct or known communication protocol in the flash memory.

13. The system of claim 9, wherein the 3D glasses includes a communication port such that the communication port could be used to add one or more communication protocols.

14. A 3D glasses apparatus, comprising:
a memory to store a plurality of communication protocols;
a controller operatively coupled to the memory to detect a transmitted communication protocol by comparing the transmitted communication protocol to the plurality of communication protocols stored in the memory;
wherein the controller receives and processes the 3D image data based on the transmitted communication protocol.

15. The apparatus of claim 14, wherein the 3D glasses includes a flash memory operatively coupled to the memory and the controller to store a predetermined number of frequently-used communication protocols.

16. The apparatus of claim 15, wherein the controller searches the flash memory, prior to searching the memory, for a correct or known communication protocol.

17. The apparatus of claim 15, wherein the controller searches the memory, after searching the flash memory, for a correct or known communication protocol.

18. The apparatus of claim 17, wherein the controller stores the correct or known communication protocol in the flash memory.

19. The apparatus of claim 15, further comprises a communication port that could be used to add one or more communication protocols.

20. The apparatus of claim 15, further comprises a communication port that could be used to delete one or more stored communication protocols.
